(19) United States
(12) Patent Application Publication
(10) Pub. No.: US 2004/0030676 A1
(43) Pub. Date: Feb. 12, 2004

(54) System and method for representation independent comparison of numerical data according to user-specified criteria

(75) Inventor: Marcus Wagner, Los Angeles, CA (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY

(21) Appl. No.: 10/213,985

(22) Filed: Aug. 7, 2002

(51) Int. Cl. G06F 7/00; G06F 17/30

(52) U.S. Cl. 707/2; 707/6

(57) ABSTRACT

A system, method and computer readable medium for comparing reference data with test data. The method includes allowing a user to specify a reference file and a test file, at least one comment marker for indicating comments, at least one token that separate numbers, at least one criterion for comparing a reference number with a test number and at least one criterion to utilize for comparing a reference number with a test number. Next, the method automatically reads the numerical data in the reference file and the numerical data in the test file in accordance with the comment marker specified by the user and the token specified by the user. Then, the method automatically compares the numerical data in the reference file with the numerical data in the test file in accordance with the at least one criterion for comparing a reference number with a test number.

### BACKGROUND OF THE INVENTION

1. Field of the Invention

This invention generally relates to the field of data verification and more specifically to comparing and verifying numerical data.

2. Description of Related Art

Anywhere in industry, comparing numerical results of tests to reference results or to legacy data can present a significant problem, because it can consume a large amount of man-hours spent on the meticulous, but tedious and error prone, work of comparing two or more possibly large sets of numbers for equality within certain limits of precision.

One area of industrial application where this problem frequently occurs, is that of verifying the correctness of the results of computer benchmarks. In this scenario, running a benchmark typically involves executing and timing one or more software applications, which can produce a large amount of numerical output. Naturally, vendors of computer software and of computer hardware want their products to generate the correct numerical results as quickly as possible and, most importantly, faster than competitive products, so as to convince a prospective customer to buy the benchmarked product based on its fast performance rather than any competitors' product. It is obvious that the generated numerical results have to be correct, and this needs to be verified. However, the verification process can consume large amounts of time and resources. (Note: Throughout this text, the numerical results that are defined as correct will be called, reference results, reference data, or reference numbers, while the to-be-verified numerical results will be called, test results, test data, or test numbers.)

One reason why the verification process can consume large amounts of time and resources is that the reference results may use a different number representation than the benchmarked application does. For example, the following lists some of the 221 different textual representations of the numerical value of “one” that are in common use, and that are often found in numerical output text files:

| | | | | | |
|---|---|---|---|---|---|
| 1 | 1. | 1.0 | 1.00 | . . . | 1.000000000000000 |
| 1e00 | 1.e00 | 1.0e00 | 1.00e00 | . . . | 1.000000000000000e00 |
| 1e+00 | 1.e+00 | 1.0e+00 | 1.00e+00 | . . . | 1.000000000000000e+00 |
| 1e+000 | 1.e+000 | 1.0e+000 | 1.00e+000 | . . . | 1.000000000000000e+000 |
| 1E00 | 1.E00 | 1.0E00 | 1.00E00 | . . . | 1.000000000000000E00 |
| 1E+00 | 1.E+00 | 1.0E+00 | 1.00E+00 | . . . | 1.000000000000000E+00 |
| 1E+000 | 1.E+000 | 1.0E+000 | 1.00E+000 | . . . | 1.000000000000000E+000 |
| 1d00 | 1.d00 | 1.0d00 | 1.00d00 | . . . | 1.000000000000000d00 |
| 1d+00 | 1.d+00 | 1.0d+00 | 1.00d+00 | . . . | 1.000000000000000d+00 |
| 1d+000 | 1.d+000 | 1.0d+000 | 1.00d+000 | . . . | 1.000000000000000d+000 |
| 1D00 | 1.D00 | 1.0D00 | 1.00D00 | . . . | 1.000000000000000D00 |
| 1D+00 | 1.D+00 | 1.0D+00 | 1.00D+00 | . . . | 1.000000000000000D+00 |
| 1D+000 | 1.D+000 | 1.0D+000 | 1.00D+000 | . . . | 1.000000000000000D+000 |

Therefore, obviously, comparing numbers based on their textual representation as, e.g., implemented by standard tools such as “diff” (in Unix) and “comp” (in Windows), or even based on the numbers' binary representation, implemented by cmp (Unix), is not a viable option to verify the equality of test data and of reference data. Already due to these ubiquitously encountered differences in number representation, the readily available tools for file comparison would, most of the time, label two sets of numerical output as different even though, for the purpose of comparing the numerical values, the compared files, one containing the reference data and one the test data, should be considered equal.

Another reason why the verification process can consume large amounts of time and resources is that not only the number representation can vary between the to-be-compared reference file and test file, but also the layout of how many numbers are printed per line and how many digits are printed to represent each number, can vary between the two files. To compound the issue of file layout, e.g., the reference file can contain different comments, i.e., textual information interspersed within the numerical data, than the test file does and this is not an error of any kind. Per se, of course, comments provide useful information, such as the version and the revision number of the software program and libraries used to produce the output file, the used operating system and hardware environment, copyright information, the list of authors (which tends to grow between successive software versions), known problems, etc. However, for the automated comparison of two large sets of numbers, this constitutes an obstacle, as one can no longer match the N-th character token in the result file with the N-th character token in the reference file and assume that both tokens represent the same, N-th number. So, the N-th token could represent the K-th number in a reference file, but represent a word of comment information in the test file.

Another reason why the verification process can consume large amounts of time and resources is that in an effort to let their software or hardware product perform well, a computer vendor will tune the benchmarked applications within limits allowed by the prospective customer. For a software application, this will typically involve choosing the best set of compiler options and sometimes, it may also involve rewriting portions of the benchmarked software, so as to maximize its execution speed. A crucial trade-off here is that more aggressive code optimization by the compiler tends to produce slightly different results, and the same almost always holds true in the case of source code modifications of the benchmarked software.

In this context, one cannot over-emphasize that a different result does not have to be less precise or less reliable than the original result. E.g., the floating-point multiply-and-add instruction that many computer chip makers implement is an example of an optimization that can produce a different, but more precise result than the separate execution of a multiplication and an addition. Another example arises in the case of comparing numerical results obtained on a current computer architecture with those obtained on a traditional Cray computer which have a publicly known, but vendor specific, machine-internal number representation (bits for mantissa and exponent) that does not conform to the otherwise commonly accepted IEEE-754 standard. Cray computers are a prime example of this phenomenon and they still constitute a significant, though aging, fraction of the computer installations used for technical computing applications.

However, as is obvious in the case of medical applications or industrial control applications, a customer, while often well aware that different does not necessarily imply worse, can not accept arbitrary deviation of results produced by benchmarked software applications from reference results. On the other hand, as is evident if the old reference results were obtained on a legacy hardware architecture or software application, it may not be feasible on modern computing platforms to obtain numerical results that are bit-identical to the legacy reference results, even if it is possible to obtain more precise results. Typically, a customer will have an expectation or requirement of how precisely the produced benchmark results must match the reference results, be that in absolute terms (e.g., no deviation more than 0.001 above and no more than 0.0002 below), or in relative terms (e.g., no more than a factor of 0.000000001 above or below) with respect to the reference result, or even in terms of statements like, “only the last digit may differ”, or, “only the first six digits are important”. Such requirements can occur combined, and are likely to differ for each potential customer, and even for different software applications benchmarked for the same customer.

If the result of a benchmark consists of a single number, then comparing the reference result and the test result is no problem. However, if the result consists of many different test cases (e.g., a well-known computational chemistry application is shipped with over 400 test cases), each of which may produce a large amount of output data, then the problem of verifying that the obtained results match the customer's reference results within customer specified limits, is very important.

One reason for the importance of verifying that the obtained results match the customer's reference results within customer specified limits is that sometimes bench-markers are forced to be overly conservative in pursuing optimization in an attempt to avoid even acceptably small deviations of their benchmark results from the customer's reference results, because the existing deadlines may not allow them to compare their test results in detail to the customer's reference results, and it must be avoided that the customer later finds unacceptably large deviations, which would invalidate the measured application timing, undermine the trust of the potential customer in the computer vendor and, very likely, can result in the loss of the sales opportunity. However, being too conservative in the optimization is going to lead to suboptimal performance and hence, may cause the loss of the sale, because a competitor may be reporting faster runtime performance. Obviously, being forced to guess, rather than verify, the most aggressive set of compiler options that is still going to result in sufficiently accurate test results, compromises the computer vendor's competitiveness.

Another reason for the importance of verifying that the obtained results match the customer's reference results within customer specified limits is that even if it were feasible, the explicit manual verification of the results would imply substantial cost, because employees would have to carry out this work which is error prone and tedious but requires full attention. Moreover, this manual comparison would delay computer vendor's response to the customer, again, impacting the computer vendor's competitiveness.

Given the surge of bio-informatics applications that process multi-gigabyte size files and produce multi-megabyte size output files and given the tendency of the biological databases to grow rapidly, the need to automate the comparison benchmark results independent of their textual representation and within specified limits of precision, is significant and growing fast.

Another promising area of application of this invention is in the testing of numerical software applications and libraries. When a computer software vendor develops new numerical software, such as engineering applications, often, new algorithms are being implemented to solve problems faster than could be done before. However, the developer must verify the correct functioning of the new software and one of the commonly used methods is, to let the new software application solve an old problem with a known solution which can then be explicitly verified.

Obviously, this poses the same set of problems as outlined above, although here the competition with other computer vendors is more indirect, through software release deadlines and through profit margins, which would be diminished by spending more labor cost on the verification of test results that is necessary.

Therefore, a need exists to overcome the problems with the prior art as discussed above, and particularly for a way to efficiently verify numerical data.

### SUMMARY OF THE INVENTION

Briefly, in accordance with the present invention, disclosed is a system, method and computer readable medium for comparing reference data with test data. In an embodiment of the present invention, the method on a computer system includes allowing a user to specify a reference file including numerical data and a test file including numerical data. In addition, the user is allowed to specify at least one comment marker for indicating comments, at least one token that separate numbers, at least one criterion for comparing a reference number with a test number and at least one criterion to utilize for comparing a reference number with a test number. Next, the method automatically reads the numerical data in the reference file and the numerical data in the test file in accordance with the at least one comment marker specified by the user and the at least one token specified by the user. Then, the method automatically compares the numerical data in the reference file with the numerical data in the test file in accordance with the at least one criterion for comparing a reference number with a test number specified by the user. Finally, the comparison results are provided to the user.

In an embodiment of the present invention, the method includes a first set of comment markers and a second set of comment markers. Subsequently, upon the automatic reading of the numerical data in the reference file and the numerical data in the test file, the reading is performed in accordance with the first set of comment markers and the second set of comment markers specified by the user and the at least one token specified by the user.

The described embodiments of the present invention are advantageous as they allow for the quick and easy user input of comparison data, such as comment markers, token separators and comparison criteria. This allows for quick adaptation of the application of the present invention to varying situations involving different types of comments, token separators, etc. Another advantage of the present invention is that the method of the present invention allows for the use of more than one comparison criteria. This results in increased usability and extendibility of the application of the present invention, as well as increased accuracy of the results of the comparison.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2A is a flowchart depicting the operation and control flow of the overall process of FIG. 1 of the present invention.

FIG. 2B is a flowchart depicting the operation and control flow of the user information setup process of FIG. 1 of the present invention.

FIG. 3A is a flowchart depicting the operation and control flow of the comparison process of FIG. 1 of the present invention.

FIG. 3B through FIG. 12C are flowcharts depicting in more detail the operation and control flow of the comparison process of FIG. 3A using pseudo-code, according to the present invention.

FIG. 13 is a block diagram of a computer system useful for implementing the present invention.

### DESCRIPTION OF THE PREFERRED EMBODIMENTS

Overview

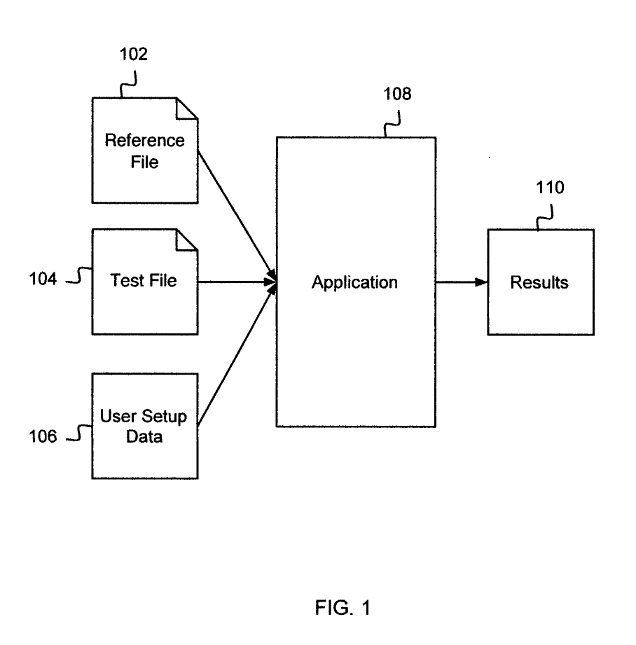

FIG. 1 is a block diagram illustrating the overall system architecture of one embodiment of the present invention. A user desires to compare numerical data in the reference file 102 with numerical data in the test file 104. Computer application 104 offers numerical data comparing functionality to the user. Thus, the user enters user setup data 106 into application 104. User setup data 106 indicates to application 108 the manner in which to compare the numerical data in the reference file 102 with numerical data in the test file 104. User setup data 106 is entered into application 108 via a graphical user interface, a command line interface or via a text file that is read by application 108. User setup data 106 is described in greater detail below. Upon completion of the comparison process by application 108, results 110 of the comparison are produced. The form of results 110 is in electronic format, hardcopy format or any other format known in the art for representing numerical data.

Reference file 102 and test file 104 are computer files or documents including numerical data or data streams including numerical data. In an alternative, reference file 102 and test file 104 are hardcopy documents that are subsequently scanned and converted into an electronic copy. The format of reference file 102 and test file 104 is any format known in the art for representing numerical data. The format of reference file 102 and test file 104 is inconsequential to the present invention as the present invention supports the use of various formats.

The computer system on which application 108 executes is one or more Personal Computers (PCs) (e.g., IBM or compatible PC workstations running the Microsoft Windows 95/98/2000/ME/CE/NT/XP operating system, Macintosh computers running the Mac OS operating system, or equivalent), Personal Digital Assistants (PDAs), game consoles or any other computer processing devices. In another embodiment of the present invention, the computer system on which application 108 executes is one or more server systems (e.g., SUN Ultra workstations running the SunOS or AIX operating system or IBM RS/6000 workstations and servers running the AIX operating system).

In an alternate embodiment of the present invention, application 108 is distributed over a network. The network is a circuit switched network, such as the Public Service Telephone Network (PSTN). In another embodiment of the present invention, the network is a packet switched network. The packet switched network is a wide area network (WAN), such as the global Internet, a private WAN, a local area network (LAN), a telecommunications network or any combination of the above-mentioned networks. The network is a wired network, a wireless network, a broadcast network, a multicast network, or a point-to-point network.

Operation of the Invention

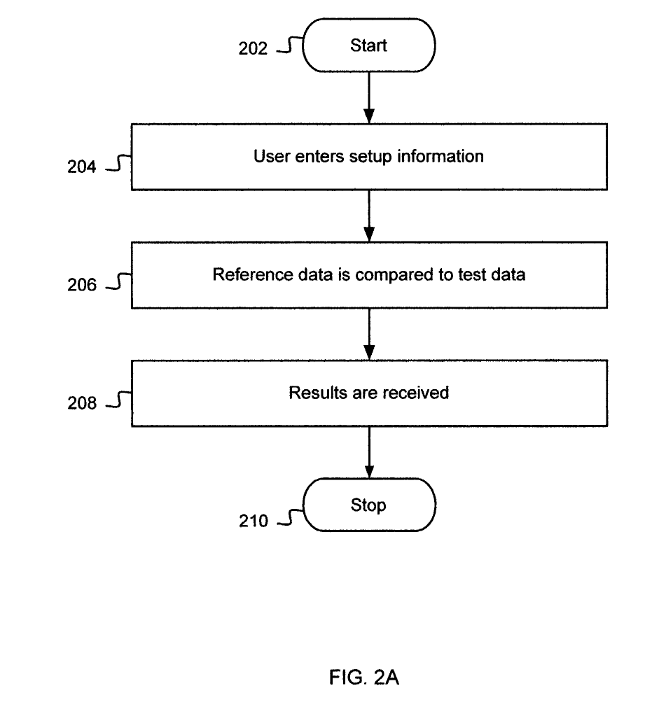

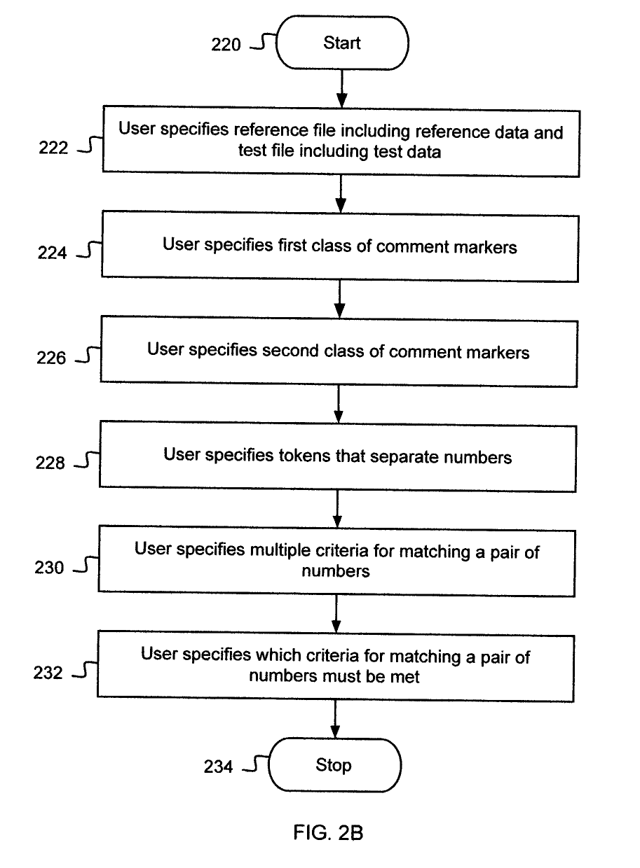

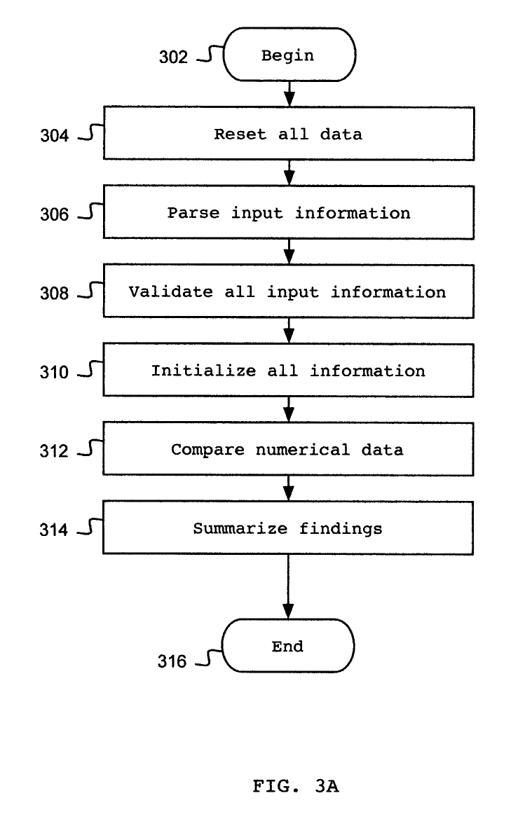

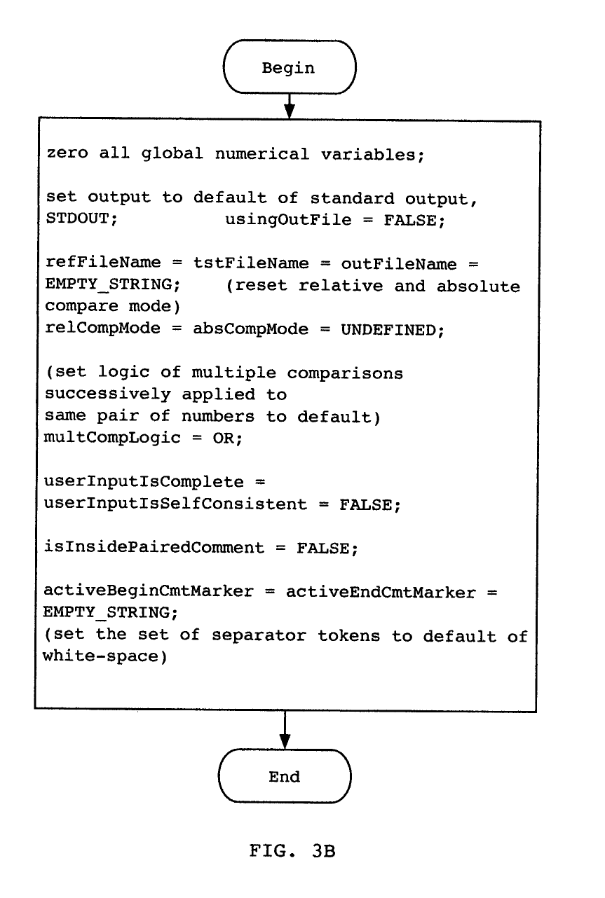

FIG. 2A is a flowchart depicting the operation and control flow of the overall process of FIG. 1 of the present invention. The control flow of FIG. 2 begins with step 202 and flows directly to step 204. In step 204, a user enters setup data 106 into application 108. User setup data 106 is described in greater detail in FIG. 2B. In step 206, the application 108 reads in the reference file 102 specified by the user, the test file 104 specified by the user and proceeds to compare the numerical data in the reference file 102 with the numerical data in test file 104 in accordance with the user setup data 106 specified by the user. The comparison process is described in greater detail in FIG. 3A through FIG. 12C. In an embodiment, the application 108 utilizes a reader module for reading in the reference file 102 and the test file 104. In another embodiment, the application 108 utilizes a comparison module for comparing the numerical data in the reference file 102 with the numerical data in test file 104.

In step 208, the results of the comparison process of step 206 are presented to the user. In step 210, the control flow of FIG. 2A ceases.

FIG. 2B is a flowchart depicting the operation and control flow of the user information setup process of FIG. 1 of the present invention. FIG. 2B describes in more detail the user setup process of step 204 of FIG. 2A. The control flow of FIG. 2B begins with step 220 and flows directly to step 222. In step 222, the user specifies the reference file 102 and the test file 104. The user performs this task by entering the names and/or paths of the reference file 102 and the test file 104 or by selecting reference file 102 and the test file 104 from a graphical user interface window.

It should be noted that the importance of step 222 lies with the distinction between test data and reference data. This is relevant when computing deviations of test values relative to reference values, and when a distinction is made between a test value exceeding a reference value and a test value falling below a reference value, i.e., comparisons using relative maximum deviations and comparisons using signed (absolute or relative) comparisons will, typically, not be commutative.

In step 224, the user specifies a first class of comment markers. A comment is a character or a set of characters that indicate that certain text should be considered only a comment and not a part of the source code or the data that is being presented. The user may specify comments in almost arbitrary ways. The user can specify two distinct classes of tokens to be considered as comment markers in both the reference file and the test file, where any comment marker can consist of one or more characters.

The first such class are to-end-of-line comment markers. All characters on a line, from the beginning of a user-specified to-end-of-line comment marker to the end of the line where that to-end-of-line comment marker appears, are ignored as comments. For example, consider the following two lines:

#Version 1.0 11/08/2000

#Version 1.1 10/07/2001

The preceding two lines would be listed as a mismatch if compared, because the two well-formed numbers, 1.0 and 1.1, are different. If the user would specify the character, ‘#’, as a to-end-of-line comment marker, these lines would be ignored and the mismatch between 1.0 and 1.1 would not be listed. Equivalently, the user could specify “Version” as a to-end-of-line comment marker. Commonly used examples of to-end-of-line comment markers are: ‘#’, ‘C’, ‘!’, “//”, “--”. There is no limit to the number of different user-specified to-end-of-line comment markers. A commonly known comment marker used in the C++ programming language is “//”. This set of characters indicates that all text after the comment and to the end of the line is a comment.

In step 226, the user specifies a second class of comment markers. The second class of comment markers the user can specify are, paired comment markers. All characters between the begin-comment marker and the corresponding end-comment marker, where both markers are treated as part of the ignored comment, and where the begin-comment marker and the end-comment marker can be on the same line or on arbitrarily far separated lines, are ignored as comments. A paired comment marker is fully specified only when both the begin-comment marker and the corresponding end-comment marker have been specified by the user. For user-input to be considered syntactically correct, the user must specify exactly one end-comment marker for each begin-comment marker. Paired comment markers can consist of one or more characters and there is no limit on the number of paired comment markers that a user of this invention can specify. Commonly used examples of pairs of begin-comment and end-comment markers are: ‘{’ and ‘}’, “(*“and”*)”, “/*” and “*/”.

Another commonly known comment marker used in the C++ programming language is “/*” and “*/”. This set of characters (a beginning set and an ending set) indicates that all text after the beginning comment marker set and to the ending comment marker set is a comment.

In step 228, the user specifies at least one token that separates numbers in the reference file 102 and the test file 104. Application 108 can also recognize the default separation of white-space and line breaks between numbers. It may be necessary to compare directly adjacent numbers without white-space separating them. For example, consider the following two lines:

1.234e−10−5.678e+05−3.141e+00

1.235e−10−9.875−e11 5.678e+05−3.142e+00

The problem with the preceding two lines is to recognize 1.234e−10−9.876e−11 as the two numbers, 1.234e−10 and −9.876e−11, and to recognize 5.678e+05−3.141e+00 as the two numbers, 5.678e+05 and −3.141e+00. This problem is often found in scientific program output where the authors of the programs tried to save space and left none between successive numbers, if the following number has a leading sign, i.e., ‘−’ and sometimes also an explicitly printed ‘+’. Application 108 solves this problem by recognizing adjacent numbers that are otherwise correctly formed, but that have no white-space separating them, by utilizing the tokens specified by the user in step 228.

In another example, consider the following two lines:

# History: Harry Hacker: fixed last bug on 10/11/2001

# History: Harry Hacker: fixed very last bug on 10/12/2001

In the preceding two lines, the dates would normally not be recognized as numbers. However, if the user specified the forward slash ‘/’ as a separator token, then the first line will be seen as containing the three numbers, 10, 11, and 2001, and the second line as containing the three numbers, 10, 12, and 2001, where 11 and 12 would be listed as a mismatch, provided this deviation exceeded the user-specified limits.

In another example a benchmark result may produce an output line such as TOTAL ENERGY=987.65(0.43), which should be understood as TOTAL ENERGY=987.65 with a standard deviation of 0.43. The problem here is that neither 987.65 nor 0.43 would normally be recognized as properly formed numbers, because the single token, “ENERGY=987.65(0.43)”, is no number at all, but instead, would merely be seen as an alpha-numerical string. Application 108 solves this problem by allowing both numbers to be recognized and automatically compared, if the user specifies the three tokens, “=”, “(“, and”)” as separators.

For conciseness, it is implied below that terms such as “numbers” and “numerical data” that are compared between the reference file and the test file, always refer to those character tokens that implement syntactically correctly formed numbers that are not commented out according to the user-specified comment markers explained above, and that are separated by white-space, end-of-line, or user-specified separator tokens.

In step 230, the user specifies at least one criterion for determining whether a match exists between a reference number from the reference file 102 with a test number from the test file 104. There are a variety of criteria for determining such a match. One method for determining a match between a reference number and a test number includes determining whether the two numbers are equal or identical. If so, then a match exists between the two numbers. If not, a mismatch exists between the two numbers. For example, if the following equation is true, then a match exists between the two numbers: R=T, where R is the reference number and T is the test number.

Another method for determining a match between a reference number and a test number includes determining whether the two numbers are substantially similar. If so, then a match exists between the two numbers. If not, a mismatch exists between the two numbers. Following are described several criteria for determining whether a reference number and a test number are substantially similar.

One criterion maintains that if the difference between the reference number and the test number does not exceed a threshold value, then a match exists between the two numbers. If the following equation is held to be true, then a match exists between the reference number R and the test number T:

|T−R|<=ABS_{—}MAX_{—}DEV

where ABS_MAX_DEV is a non-negative value. If |T−R| exceeds ABS_MAX_DEV, then the reference number and the test number, along with their positions in the respective file containing that number, are listed as a mismatch. If not specified by the user, the default value of ABS_MAX_DEV is zero. As a mutually exclusive alternative to ABS_MAX_DEV, the user can specify ABS_MAX_DEV_ABOVE and ABS_MAX_DEV_BELOW, where the sign of the magnitude of the deviation is taken into account. The user can specify any one, or both, of ABS_MAX_DEV_ABOVE and ABS_MAX_DEV_BELOW, but one can not mix either of ABS_MAX_DEV_ABOVE and ABS_MAX_DEV_BELOW with ABS_MAX_DEV. By setting MAX_DEV_ABOVE and ABS_MAX_DEV_BELOW to the same value, ABS_MAX_DEV_ABOVE and ABS_MAX_DEV_BELOW are combined to have the same meaning as ABS_MAX_DEV.

Another criterion maintains that if the test number does not exceed the reference number by a threshold value, then a match exists between the two numbers. If the following equation is held to be true, then a match exists between the reference number R and the test number T:

T−R <=ABS_{—}MAX_{—}DEV_{—}ABOVE

where ABS_MAX_DEV_ABOVE is a non-negative value. If the test number exceeds the reference number by more than ABS_MAX_DEV_ABOVE, then the reference number and the test number, along with their positions in the respective file containing that number, are listed as a mismatch. If not specified by the user, the default value of ABS_MAX_DEV_ABOVE is zero.

Another criterion maintains that if the test number does not fall below the reference number by a threshold value, then a match exists between the two numbers. If the following equation is held to be true, then a match exists between the reference number R and the test number T:

R−T<=ABS_{—}MAX_{—}DEV_{—}BELOW

where ABS_MAX_DEV_BELOW is a non-negative value. If the test number is smaller than the reference number by more than ABS_MAX_DEV_BELOW, then the reference number and the test number, along with their positions in the respective file containing that number, are listed as a mismatch. If not specified by the user, the default value of ABS_MAX_DEV_ABOVE is zero.

However, relying on absolute values (above or below) alone for the specification of the maximum tolerable deviation from the test number is not sufficient, because the numerical output of a benchmark can, and often does, contain numbers of very large magnitude as well as numbers of very small magnitude, e.g., 6.023E+23 and 1.602E−19. In this example, specifying a value of 1E20 for ABS_MAX_DEV would imply that the number compared to 6.023E+23 would match 6.023E+23 only if it is no larger than 6.024E+23 and no smaller than 6.022E+23, i.e., 1/6023 is the largest acceptable relative deviation between the reference number and the test number. A problem with relying on this specification alone, is, that 1.602E−19 and −1.602E−18 would match, even though the relative deviation is a factor of minus 10, i.e., one number could represent one positive elementary charge and the other number minus ten elementary charges. Almost certainly, in a chemistry application, this should be considered a mismatch.

Conversely, insisting on a very small value for ABS_MAX_DEV would treat the comparison of small absolute valued numbers as the user intends, but it would tend to list large absolute valued numbers as mismatches, even though there, the relative deviation might be very small and well within the tolerance interval acceptable to the user. Therefore, comparing numerical results based solely on the magnitude of the differences between reference numbers and test numbers alone, is not sufficiently flexible for an industrial strength tool to verify benchmark results.

Another criterion maintains that if the difference of the test number and the reference number, divided by the reference number, does not exceed in absolute value a threshold value, then a match exists between the two numbers. If the following equation is held to be true, then a match exists between the reference number R and the test number T:

|T−R|/|R|<=REL_{—}MAX_{—}DEV

where REL_MAX_DEV is a non-negative value. If this scaled difference exceeds REL_MAX_DEV then the reference number and the test number, along with their positions in the respective file containing that number, are listed as a mismatch. If not specified by the user, the default value of REL_MAX_DEV is zero. As a mutually exclusive alternative to REL_MAX_DEV, the user can specify REL_MAX_DEV_ABOVE and REL_MAX_DEV_BELOW, where the sign of the relative deviation is taken into account. The user can specify any one, or both, of REL_MAX_DEV_ABOVE and REL_MAX_DEV_BELOW, but one can not mix either of REL_MAX_DEV_ABOVE and REL_MAX_DEV_BELOW with REL_MAX_DEV. By setting REL_MAX_DEV_ABOVE and REL_MAX_DEV_BELOW to the same value, REL_MAX_DEV_ABOVE and REL_MAX_DEV_BELOW can be combined to have the same meaning as REL_MAX_DEV.

A few issues are important to point out in the comparison of numbers based on the maximum tolerable relative deviation. Let M be REL_MAX_DEV, T the test number, R the reference number and let |x| represent the absolute value of x. Then, two numbers T and R match, provided it is true that:

M>=|T−R|/|R|

However, this equation poses the problem that a division by zero can occur and, in addition, it is not very efficient in so far as divisions are numerically expensive. Therefore, this equation is equivalently expressed as:

M*|R|>=|T−R|

In this form a division by zero can no longer occur, and this comparison can be done very efficiently—not only because the division has been replaced by a multiplication, but also because the subtraction and the multiplication can be executed simultaneously as a fused multiply-and-add instruction by most processors. Obviously, the problem of the division by zero is eliminated, but any deviation of a test number from a reference number of value zero will be considered a mismatch, because M * |0|>=|T−0|, is FALSE for all T other than zero. However, even though this problem is inherent in the relative comparison, the present invention provides a work-around with the goal to achieve what a user is likely to want done in this situation, provided the user explicitly specifies this behavior:

Another criterion maintains that if the relative maximum deviation between the test number and the reference number (as specified above) does not exceed a threshold value, where the test number is larger than, or equal to the reference number and where that threshold value is assumed non-negative, then a match exists between the two numbers. If the following equation is held to be true, then a match exists between the reference number R and the test number T:

(T−R)/|R|<=REL_{—}MAX_{—}DEV_{—}ABOVE

where REL_MAX_DEV_ABOVE is a non-negative value and T>=R. The above equation may be rewritten, for the reasons stated above for REL_MAX_DEV, as:

(T−R)<=REL_{—}MAX_{—}DEV_{—}ABOVE * |R |

Another criterion maintains that if the relative maximum deviation between the test number and the reference number (as specified above) is no larger than a threshold value, where the test number does not exceed the reference number, then a match exists between the two numbers. If the following equation is held to be true, then a match exists between the reference number R and the test number T:

(R−T)/|R|<=REL_{—}MAX_{—}DEV_{—}BELOW

where REL_MAX_DEV_BELOW is a non-negative value and T<=R. The above equation may be rewritten, for the reasons stated above for REL_MAX_DEV, as:

(R−T)<=REL_{—}MAX_{—}DEV_{—}BELOW * |R|

Returning to the control flow of FIG. 2B, in step 232, the user specifies which of the at least one criterion specified by the user in step 230 shall be applied during the comparison of the reference data with the test data. I.e., the user can specify if two numbers must satisfy any one, several, or all specified match criteria, described above in greater detail. This feature allows for precise and more accurate calculations during the comparison process of application 108. In step 234, the control flow of FIG. 2B ceases.

FIG. 3A is a flowchart depicting the operation and control flow of the comparison process of FIG. 1 of the present invention. FIG. 3 describes in more detail the comparison process of step 206 of FIG. 2A. Specifically, FIG. 3A shows the overall operation of the comparison process, as described in the pseudo-code representation of the comparison process in FIG. 3B to FIG. 12C. The control flow of FIG. 3A begins with step 302 and flows directly to step 304.

In step 304, all constants and variables are reset to default values. Some default values for comparison criteria are described above. FIG. 3B shows in greater detail the pseudo-code depicting the process of resetting constants and variables.

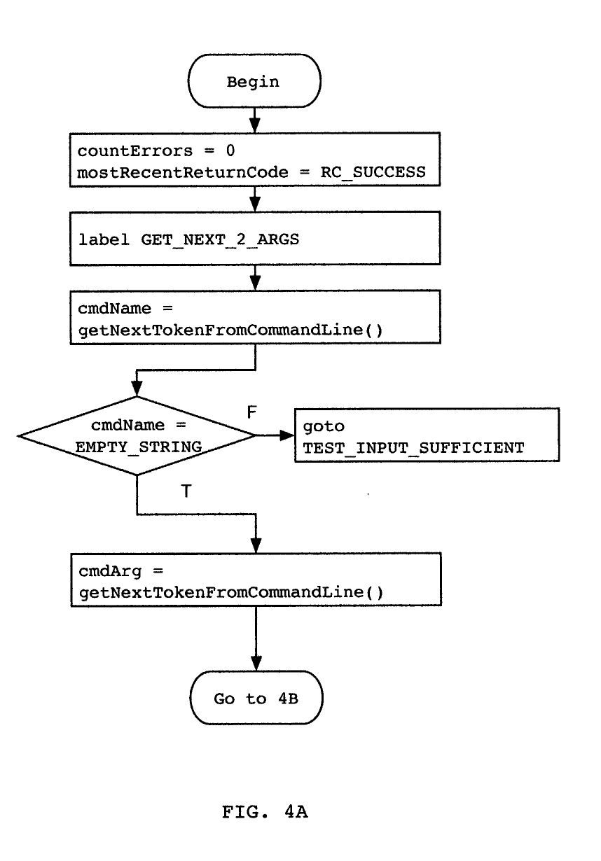

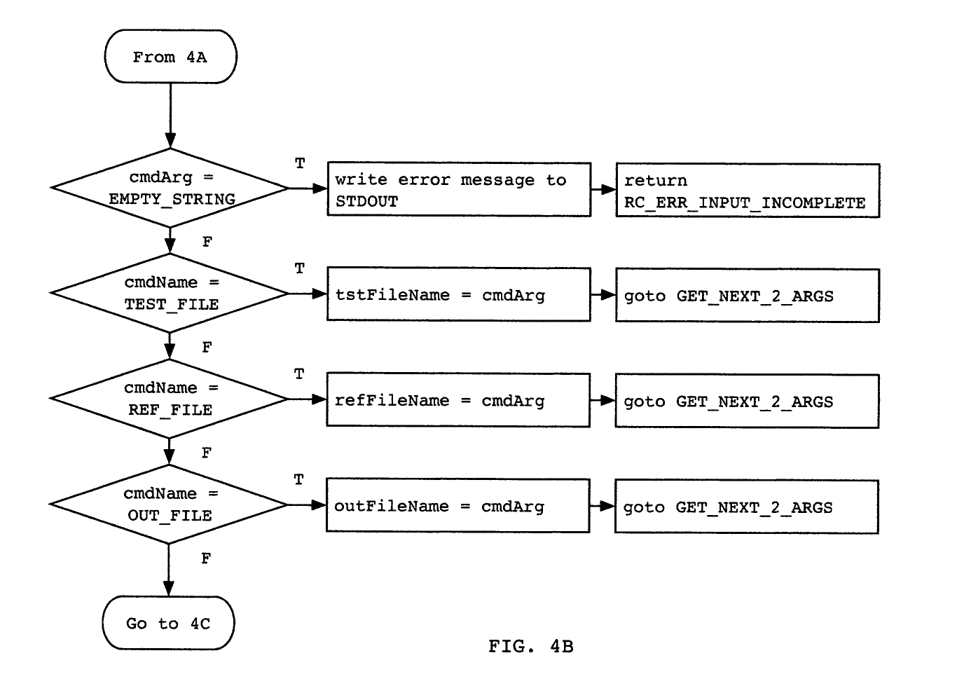

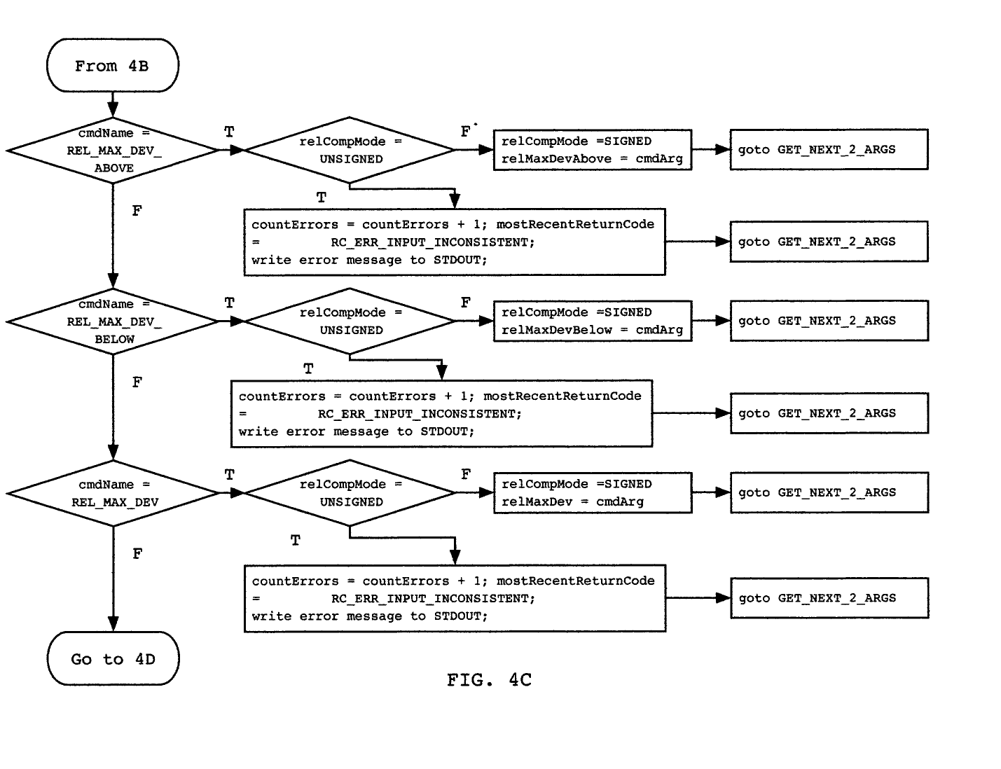

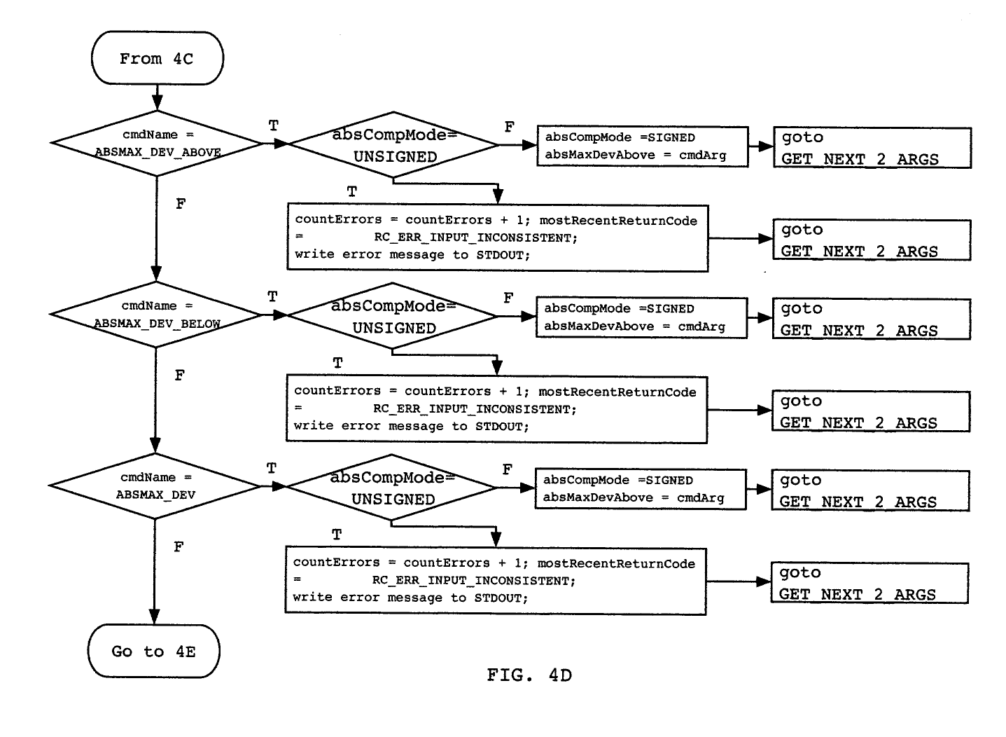

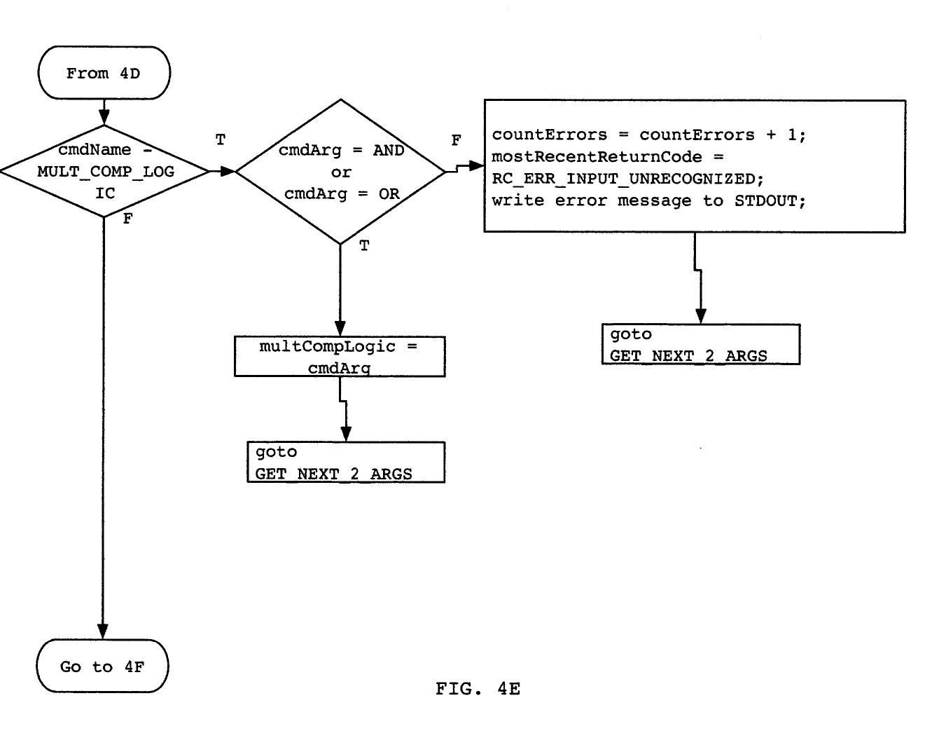

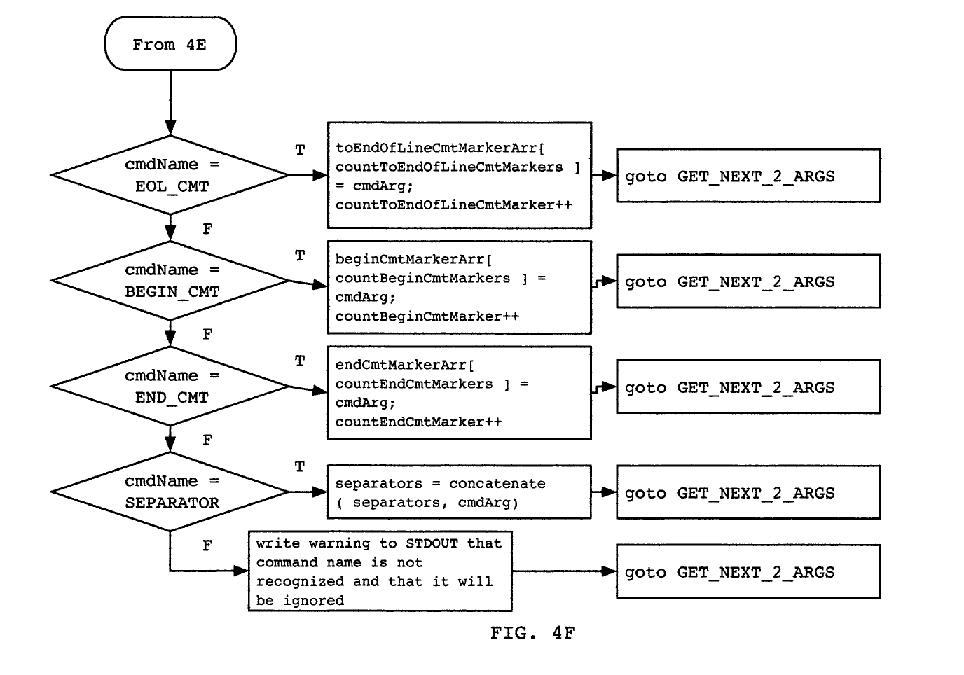

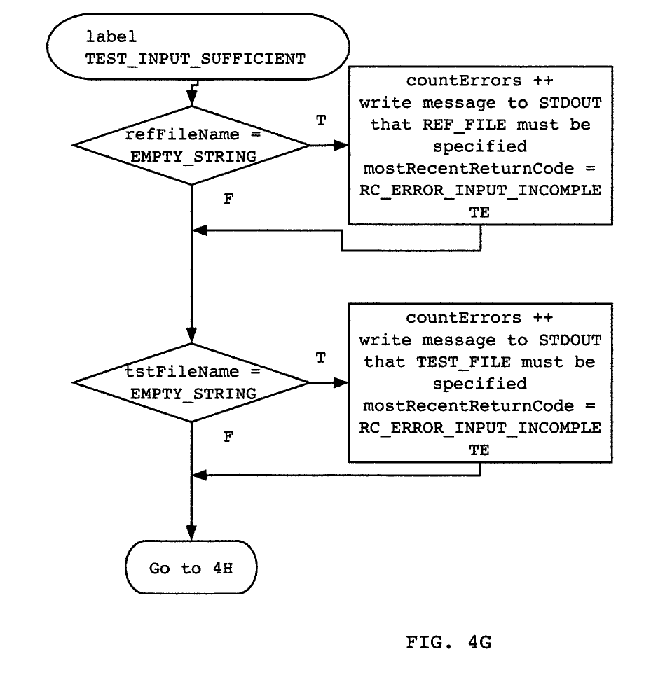

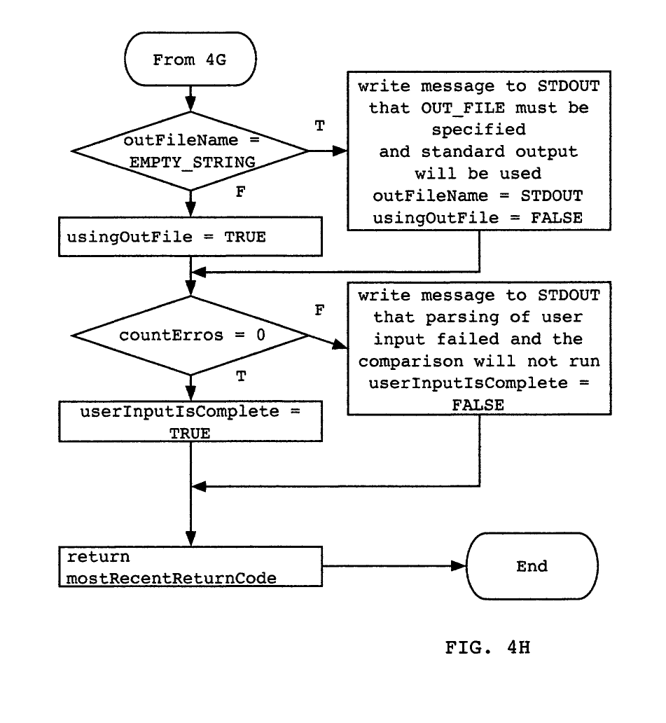

In step 306, user command information for executing application 108 is read and parsed. In this step, a command given by the user, which may include arguments that specify information used during execution, is parsed. FIG. 4A to FIG. 4H show in greater detail the pseudo-code depicting the process of parsing user command information.

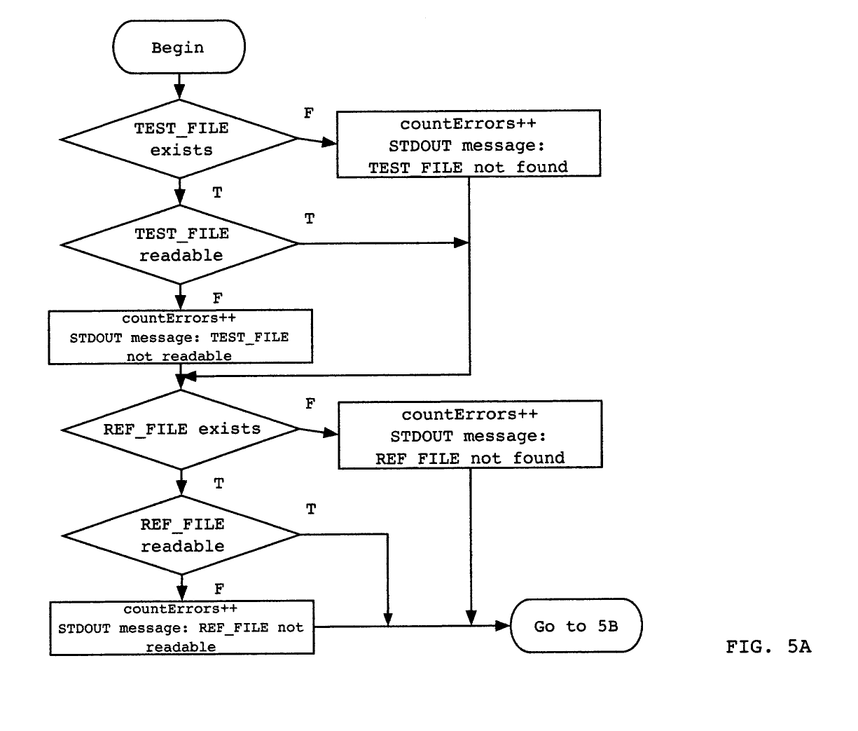

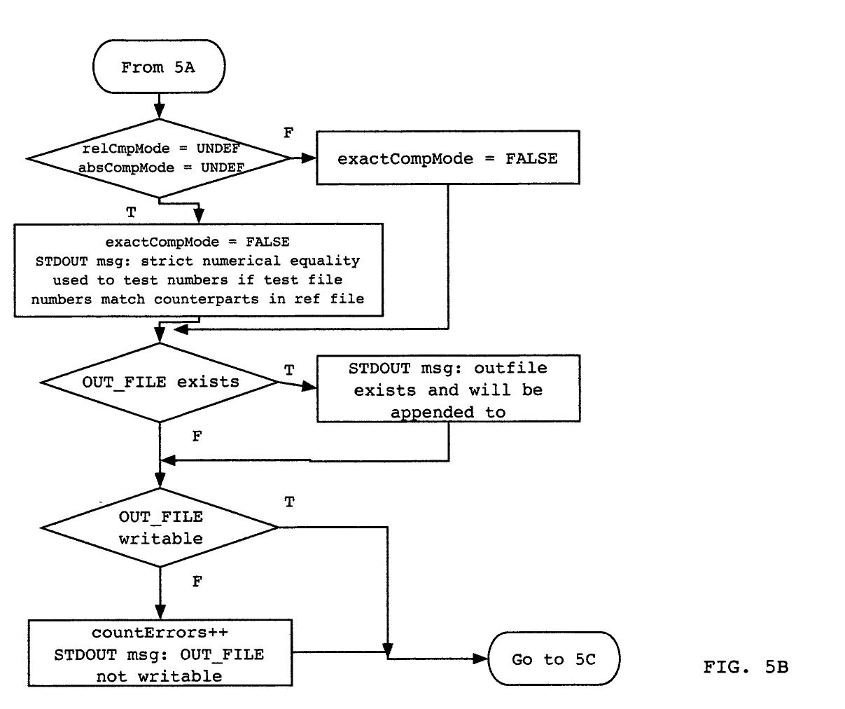

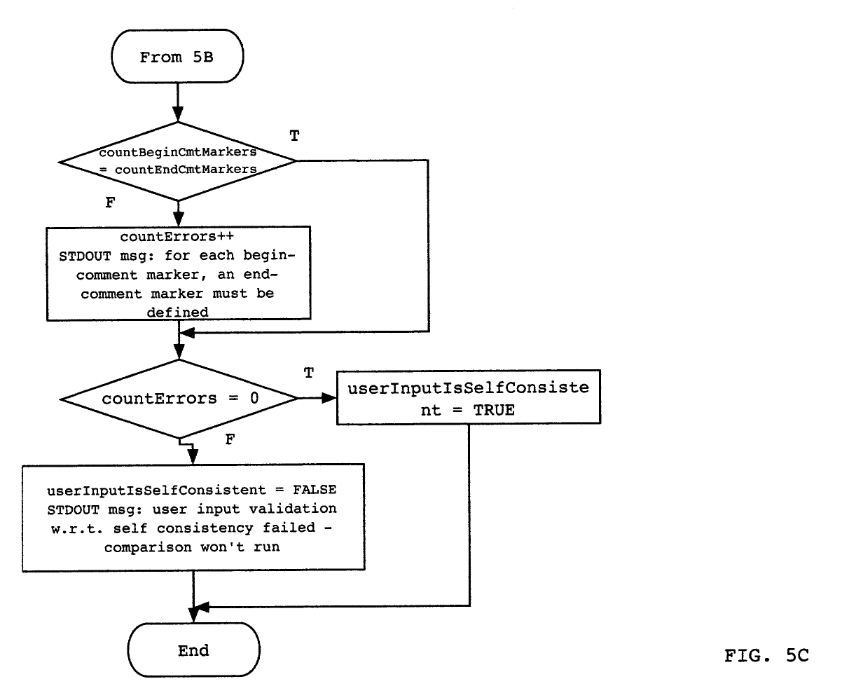

In step 308, the user command information entered above is validated. FIG. 5A to FIG. 5C show in greater detail the pseudo-code depicting the process of validating the user command information.

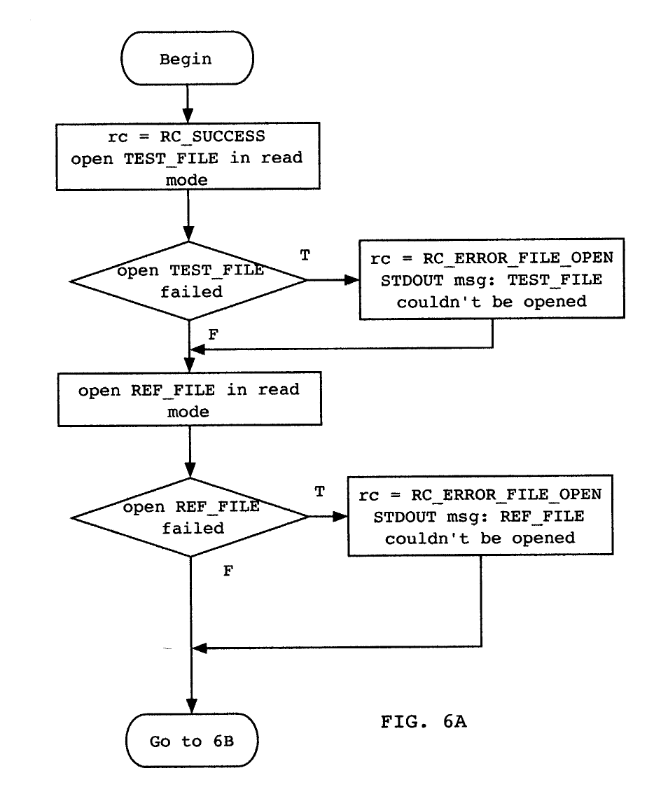

In step 310, the application 108 initializes all settings in preparation for executing. In this step, application 108 initializes all registers, checks the reference file and the test file for proper reading and output file for proper writing. FIG. 6A to FIG. 6B show in greater detail the pseudo-code depicting the process of program initialization.

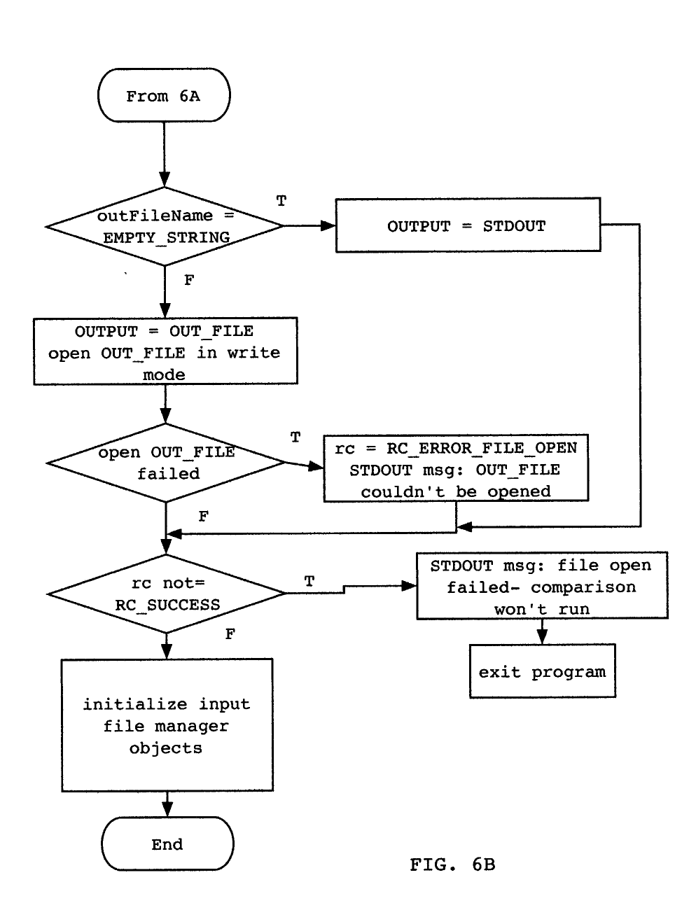

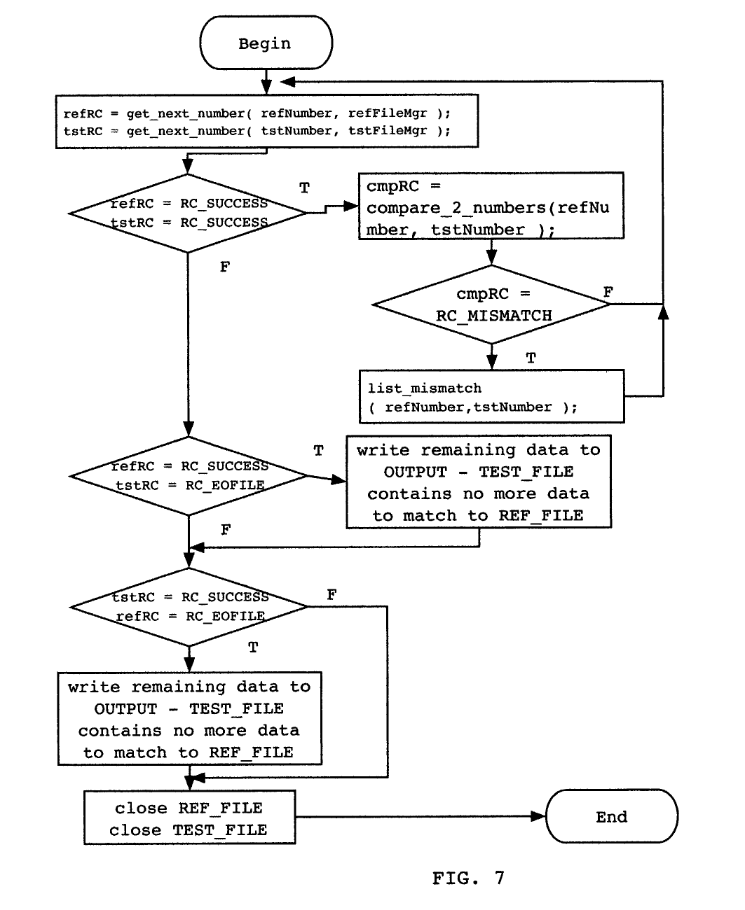

In step 312, the application 108 compares the numerical data in the reference file with the numerical data in the test file, according to the setup data specified by the user. FIG. 7 shows in greater detail the pseudo-code depicting the comparison process of the present invention.

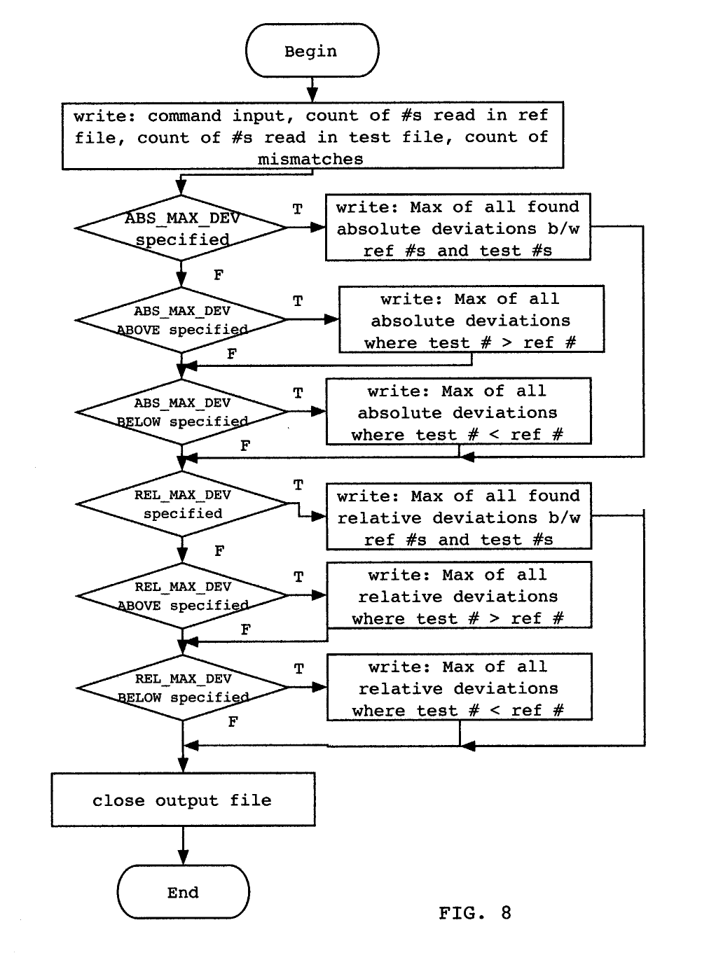

In step 314, all findings produced by the comparison process above are summarized and written to an output file. FIG. 8 shows in greater detail the pseudo-code depicting the summarization process of the present invention.

In step 316, the control flow of FIG. 3A ceases.

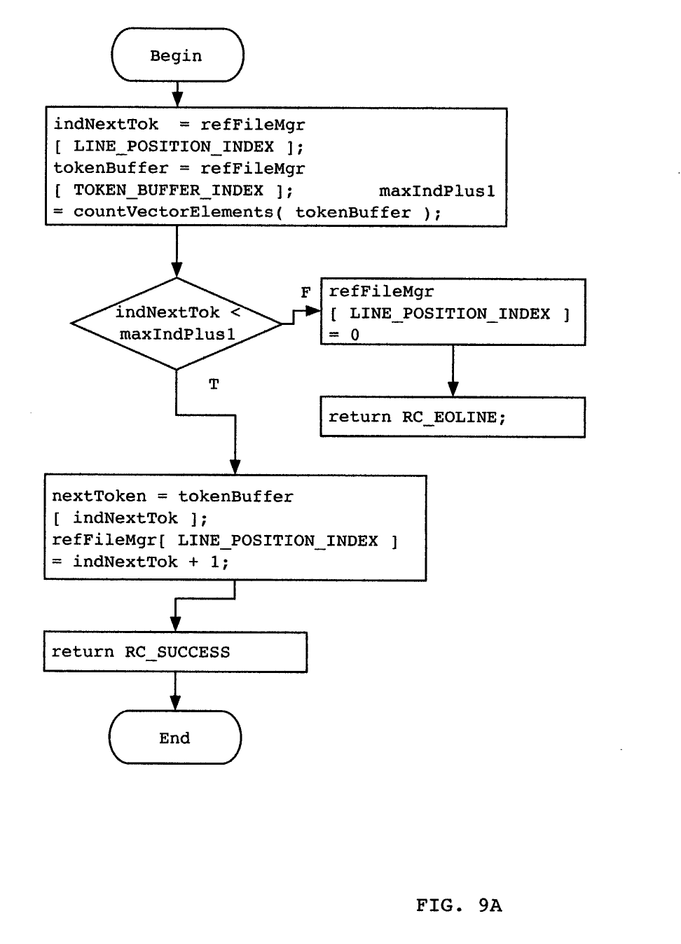

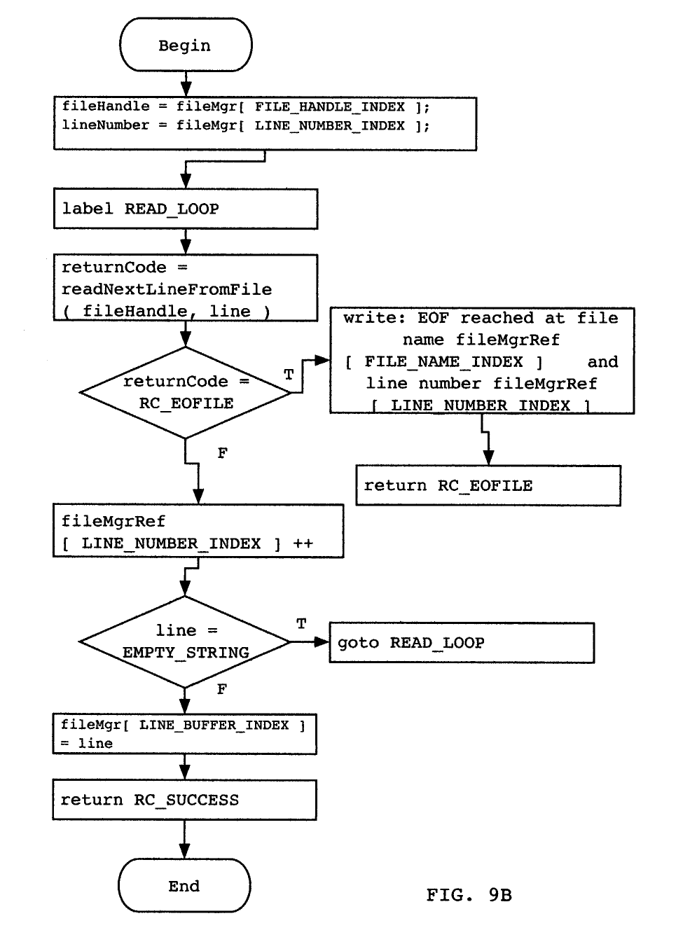

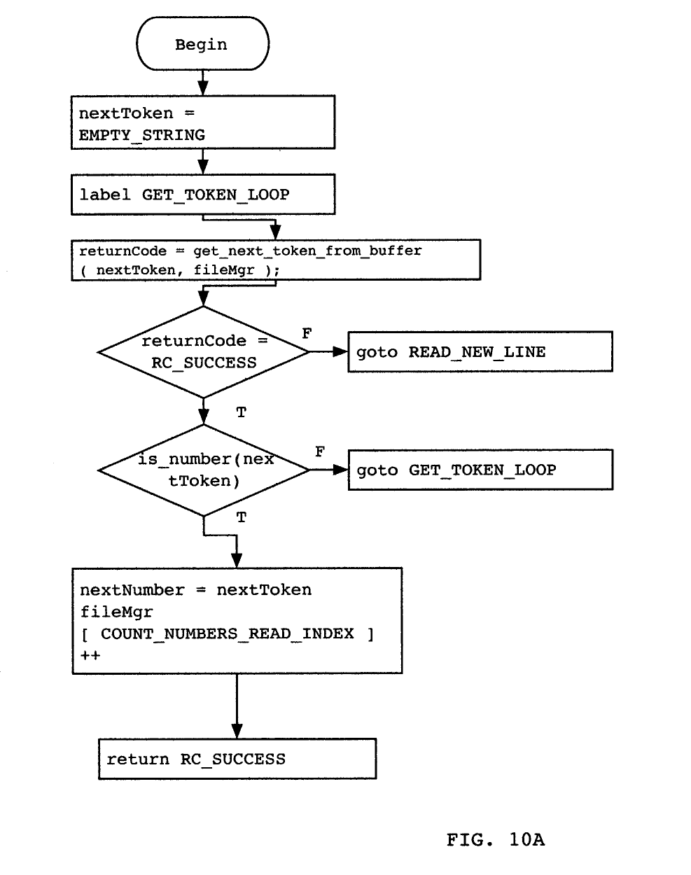

FIG. 9A shows in greater detail the pseudo-code depicting the process of reading the next data token from the buffer of data read from the reference file or the test file. FIG. 9B shows in greater detail the pseudo-code depicting the process of reading the next line the buffer of data read from the reference file or the test file.

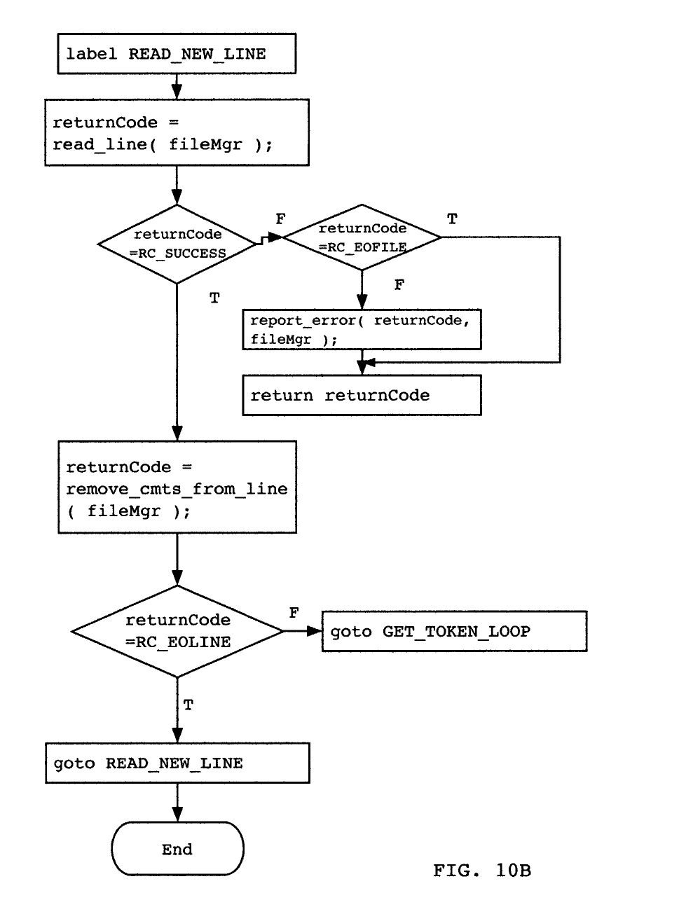

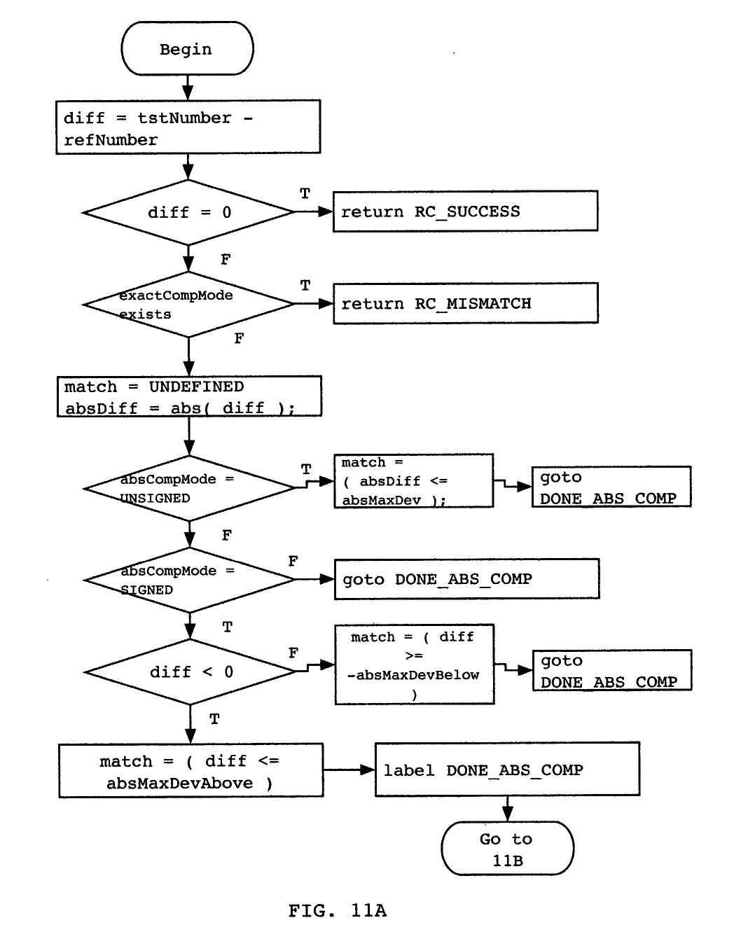

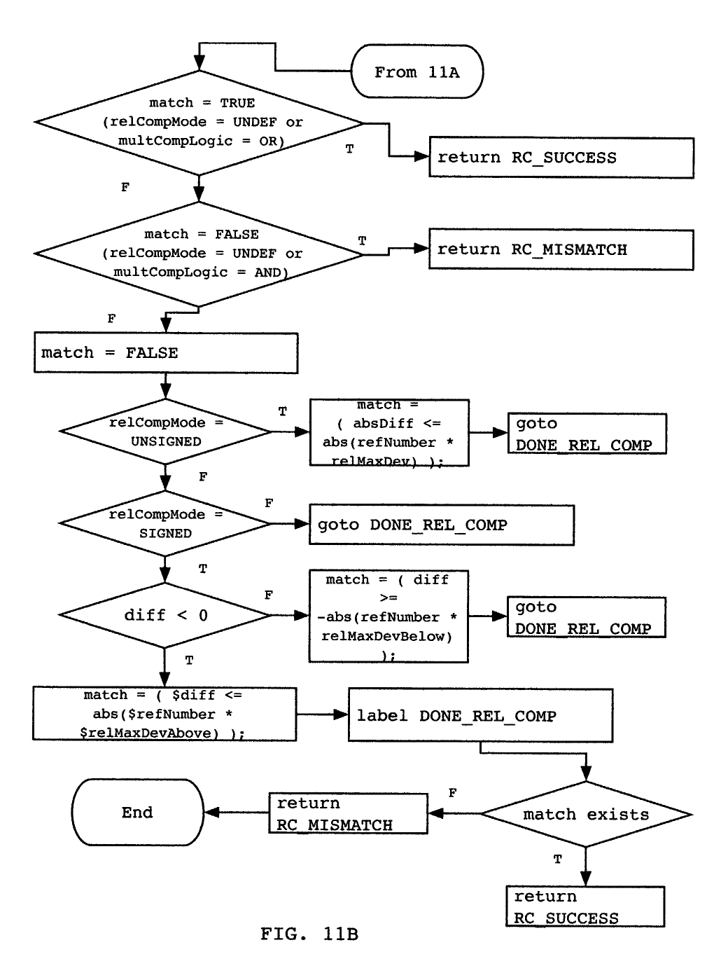

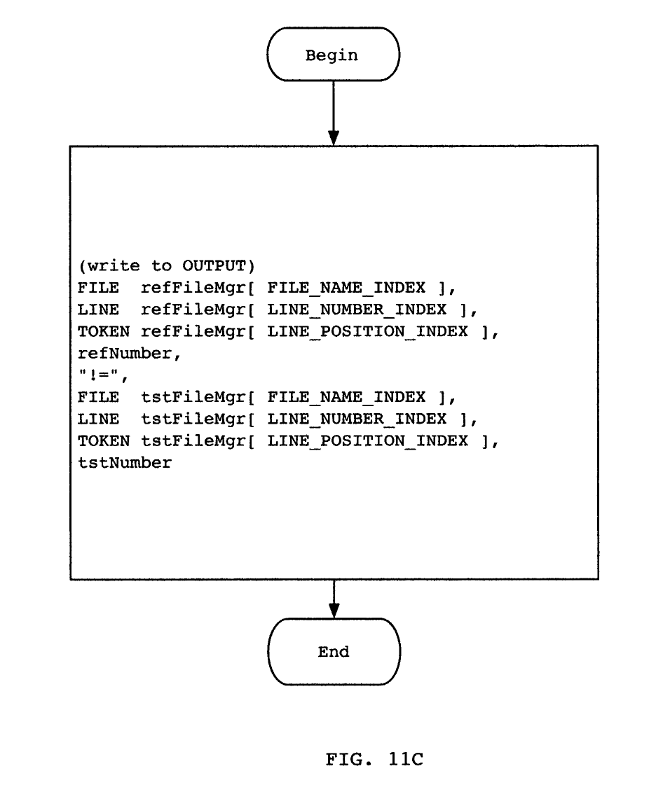

FIG. 10A to FIG. 10B show in greater detail the pseudo-code depicting the process of reading the next numerical data token from the buffer of data read from the reference file or the test file. FIG. 11A to FIG. 11B show in greater detail the pseudo-code depicting the process of comparing two numerical data tokens taken from the buffer of data read from the reference file or the test file.

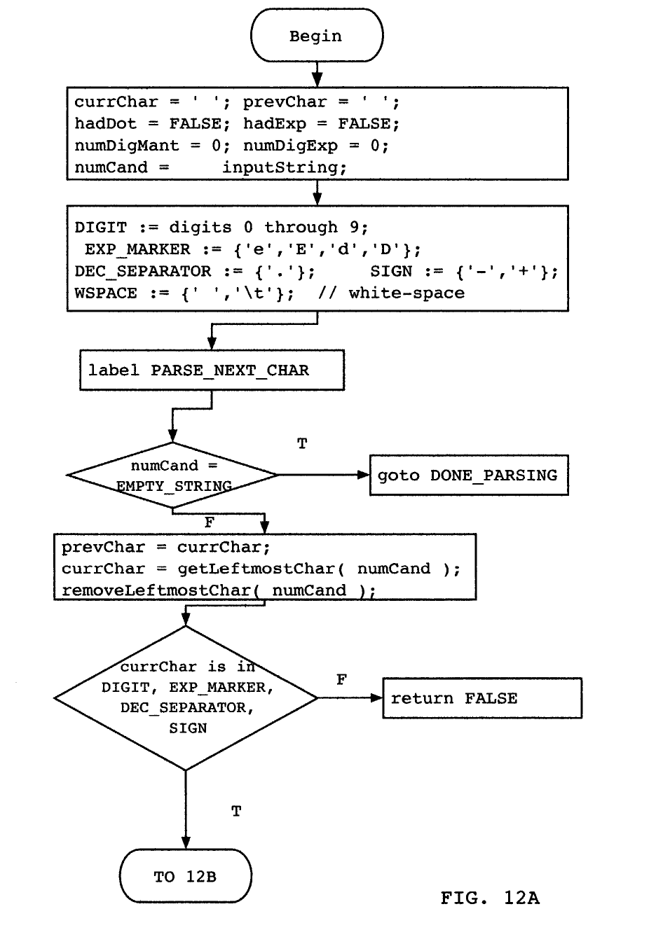

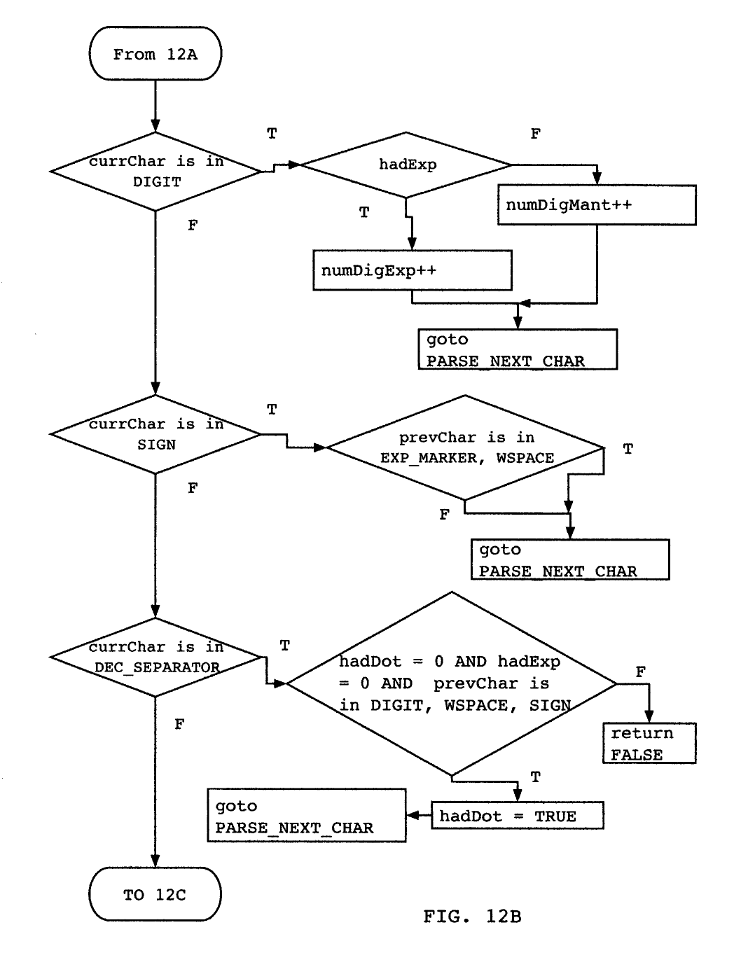

FIG. 11C shows in greater detail the pseudo-code depicting the process of logging a mismatch between two numbers in the output file. FIG. 12A to FIG. 12C show in greater detail the pseudo-code depicting the process of determining whether the next data token taken from the buffer of data read from the reference file or the test file is a number.

Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

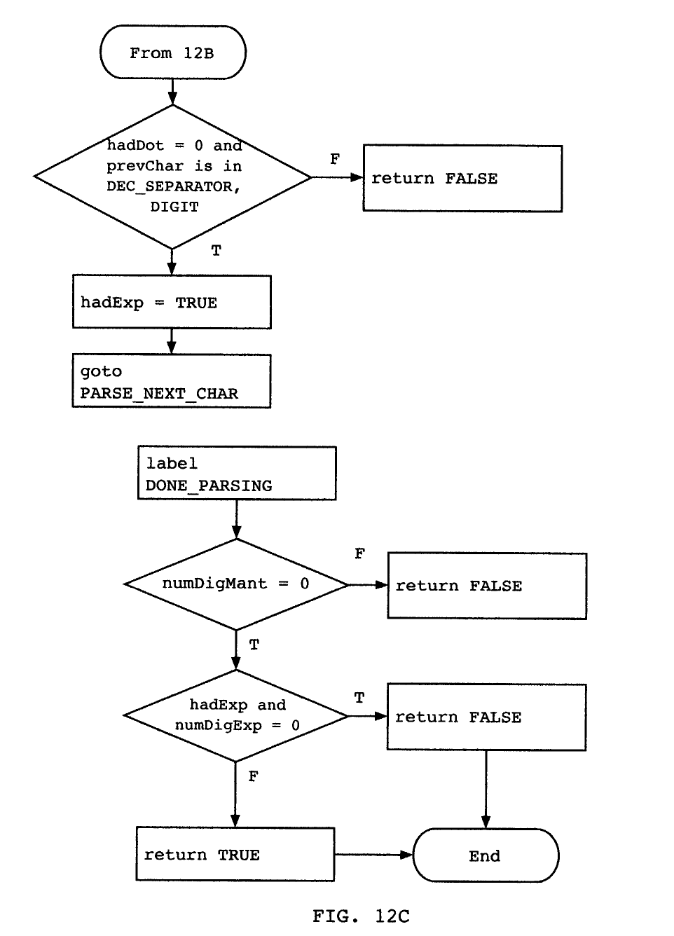

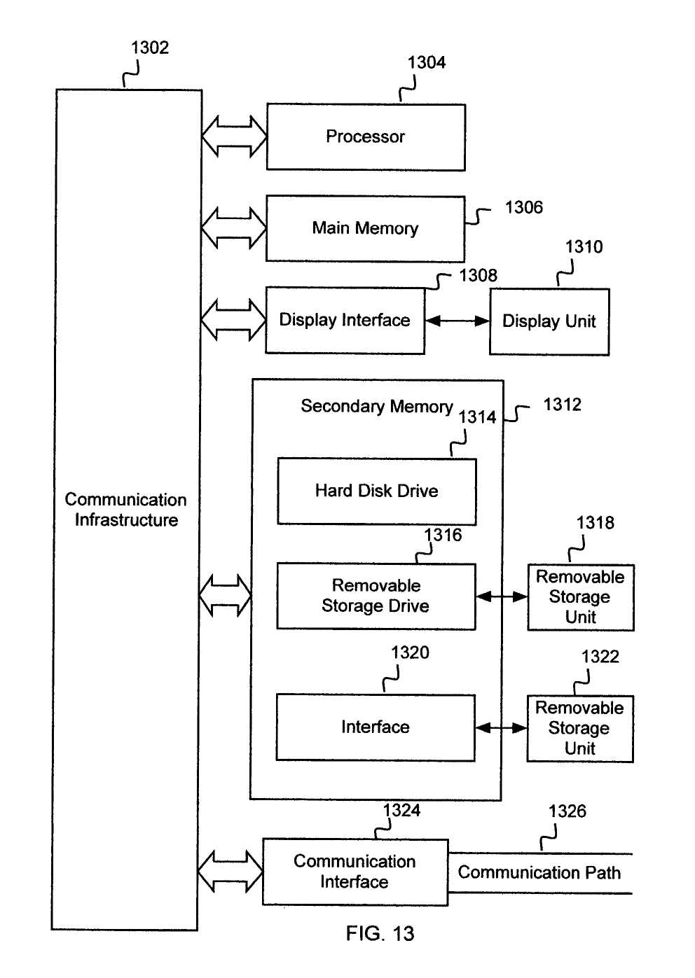

FIG. 13 is a block diagram of a computer system useful for implementing an embodiment of the present invention. The computer system includes one or more processors, such as processor 1304. The processor 1304 is connected to a communication infrastructure 1302 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1308 that forwards graphics, text, and other data from the communication infrastructure 1302 (or from a frame buffer not shown) for display on the display unit 1310. The computer system also includes a main memory 1306, preferably random access memory (RAM), and may also include a secondary memory 1312. The secondary memory 1312 may include, for example, a hard disk drive 1314 and/or a removable storage drive 1316, representing a floppy disk drive, a magnetic tape drive, an optical disk drive, etc. The removable storage drive 1316 reads from and/or writes to a removable storage unit 1318 in a manner well known to those having ordinary skill in the art. Removable storage unit 1318, represents a floppy disk, magnetic tape, optical disk, etc. which is read by and written to by removable storage drive 1316. As will be appreciated, the removable storage unit 1318 includes a computer usable storage medium having stored therein computer software and/or data.

In alternative embodiments, the secondary memory 1312 may include other similar means for allowing computer programs or other instructions to be loaded into the computer system. Such means may include, for example, a removable storage unit 1322 and an interface 1320. Examples of such may include a program cartridge and cartridge interface (such as that found in video game devices), a removable memory chip (such as an EPROM, or PROM) and associated socket, and other removable storage units 1322 and interfaces 1320 which allow software and data to be transferred from the removable storage unit 1322 to the computer system.

The computer system may also include a communications interface 1324. Communications interface 1324 allows software and data to be transferred between the computer system and external devices. Examples of communications interface 1324 may include a modem, a network interface (such as an Ethernet card), a communications port, a PCMCIA slot and card, etc. Software and data transferred via communications interface 1324 are in the form of signals which may be, for example, electronic, electromagnetic, optical, or other signals capable of being received by communications interface 1324. These signals are provided to communications interface 1324 via a communications path (i.e., channel) 1326. This channel 1326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1306 and secondary memory 1312, removable storage drive 1316, a hard disk installed in hard disk drive 1314, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1306 and/or secondary memory 1312. Computer programs may also be received via communications interface 1324. Such computer programs, when executed, enable the computer system to perform the features of the present invention as discussed herein. In particular, the computer programs, when executed, enable the processor 1304 to perform the features of the computer system. Accordingly, such computer programs represent controllers of the computer system.

Conclusion

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method on a computer system for comparing reference data with test data, the method comprising:
allowing a user to specify a reference file including numerical data and a test file including numerical data;
allowing the user to specify at least one comment marker;
allowing the user to specify at least one token that separate numbers;
allowing the user to specify at least one criterion for comparing a reference number with a test number;
allowing the user to specify which of the at least one criterion to utilize for comparing a reference number with a test number;
automatically reading the numerical data in the reference file and the numerical data in the test file in accordance with the at least one comment marker specified by the user and the at least one token specified by the user; and
automatically comparing the numerical data in the reference file with the numerical data in the test file in accordance with the at least one criterion for comparing a reference number with a test number specified by the user.

2. The method of claim 1, wherein the at least one comment marker comprises at least one character indicating that all characters after a comment marker and to the end of the current line are a comment.

3. The method of claim 1, wherein the at least one comment marker comprises at least one character indicating that all characters after the comment marker and to a next comment marker are a comment.

4. The method of claim 1, wherein the at least one token comprises at least one character indicating the end of one number and the beginning of another number.

5. The method of claim 1, wherein the at least one criterion for comparing a reference number with a test number comprises:
determining that a reference number is equal to a test number if the following equation is true:

|T−R|<=Threshold Value
wherein R is the reference number, T is the test number and the threshold value is non-negative.

6. The method of claim 5, wherein the at least one criterion for comparing a reference number with a test number further comprises:
determining that a reference number is equal to a test number if the following equation is true:
T−R<=Threshold Value
wherein R is the reference number, T is the test number and the threshold value is non-negative.

7. The method of claim 6, wherein the at least one criterion for comparing a reference number with a test number further comprises:
determining that a reference number is equal to a test number if the following equation is true:
R−T<=Threshold Value
wherein R is the reference number, T is the test number and the threshold value is non-negative.

8. The method of claim 7, wherein the at least one criterion for comparing a reference number with a test number comprises:
determining that a reference number is equal to a test number if the following equation is true:

|T−R|/|R|<=Threshold Value
wherein R is the reference number, T is the test number and the threshold value is non-negative.

9. The method of claim 8, wherein the at least one criterion for comparing a reference number with a test number comprises:
determining that a reference number is equal to a test number if the following equation is true:
(T−R)/|R|<=Threshold Value
wherein R is the reference number, T is the test number and the threshold value is non-negative.

10. The method of claim 9, wherein the at least one criterion for comparing a reference number with a test number comprises:
determining that a reference number is equal to a test number if the following equation is true:
(R−T)/|R|<=Threshold Value
wherein R is the reference number, T is the test number and the threshold value is non-negative.

11. A method on a computer system for comparing reference data with test data, the method comprising:
allowing a user to specify a reference file including numerical data and a test file including numerical data;
allowing the user to specify a first set of comment markers;
allowing the user to specify a second set of comment markers;
allowing the user to specify at least one token that separate numbers;
allowing the user to specify at least one criterion for comparing a reference number with a test number;
allowing the user to specify which of the at least one criterion to utilize for comparing a reference number with a test number;
automatically reading the numerical data in the reference file and the numerical data in the test file in accordance with the first set of comment markers specified by the user, the second set of comment markers specified by the user and the at least one token specified by the user; and
automatically comparing the numerical data in the reference file with the numerical data in the test file in accordance with the at least one criterion for comparing a reference number with a test number specified by the user.

12. The method of claim 11, wherein the first set of comment markers and the second set of comment markers comprise at least one character indicating that all characters after a comment marker and to the end of the current line are a comment.

13. The method of claim 11, wherein the first set of comment markers and the second set of comment markers comprise at least one character indicating that all characters after a comment marker and to a next comment marker are a comment.

14. The method of claim 11, wherein the at least one token comprises at least one character indicating the end of one number and the beginning of another number.

15. The method of claim 11, wherein the at least one criterion for comparing a reference number with a test number comprises:
determining that a reference number is equal to a test number if the following equation is true:

|T−R|<=Threshold Value
wherein R is the reference number, T is the test number and the threshold value is non-negative.

16. A system for comparing reference data with test data, comprising:
an interface for allowing a user to specify a reference file including numerical data and a test file including numerical data, at least one comment marker, at least one token that separate numbers and at least one criterion for comparing a reference number with a test number and at least one criterion to utilize for comparing a reference number with a test number;
a reader for automatically reading the numerical data in the reference file and the numerical data in the test file in accordance with the at least one comment marker specified by the user and the at least one token specified by the user; and
a comparing module for automatically comparing the numerical data in the reference file with the numerical data in the test file in accordance with the at least one criterion for comparing a reference number with a test number specified by the user.

17. The system of claim 16, wherein the at least one comment marker comprises at least one character indicating that all characters after a comment marker and to the end of the current line are a comment.

18. The system of claim 16, wherein the at least one comment marker comprises at least one character indicating that all characters after the comment marker and to a next comment marker are a comment.

19. The system of claim 16, wherein the at least one token comprises at least one character indicating the end of one number and the beginning of another number.

20. A computer readable medium including computer instructions for comparing reference data with test data, the computer instructions comprising instructions for:
reading user-specified data including a reference file including numerical data, a test file including numerical data, at least one comment marker, at least one token that separate numbers and at least one criterion for comparing a reference number with a test number and at least one criterion to utilize for comparing a reference number with a test number;
automatically reading the numerical data in the reference file and the numerical data in the test file in accordance with the at least one comment marker specified by the user and the at least one token specified by the user; and
automatically comparing the numerical data in the reference file with the numerical data in the test file in accordance with the at least one criterion for comparing a reference number with a test number specified by the user.

21. The computer readable medium of claim 20, wherein the at least one comment marker comprises at least one character indicating that all characters after a comment marker and to the end of the current line are a comment.

22. The computer readable medium of claim 20, wherein the at least one comment marker comprises at least one character indicating that all characters after the comment marker and to a next comment marker are a comment.

23. The computer readable medium of claim 20, wherein the at least one token comprises at least one character indicating the end of one number and the beginning of another number.

24. The computer readable medium of claim 20, wherein the at least one criterion for comparing a reference number with a test number comprises:
determining that a reference number is equal to a test number if the following equation is true:

|T−R|<=Threshold Value
wherein R is the reference number, T is the test number and the threshold value is non-negative.
